(19) United States
(12) Patent Application Publication
(10) Pub. No.: US 2004/0231537 A1
(43) Pub. Date: Nov. 25, 2004

(54) Avoiding eccentricities in shafts

(76) Inventors: Jan Dirk Boness, Bad Bramstedt (DE); Ingo Klaus Michael Dreher, Kiel (DE); Frank Pierel, Kiel (DE); Stefan Schrader, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/704,505

(22) Filed: Nov. 7, 2003

(30) Foreign Application Priority Data
Nov. 15, 2002 (DE) 102 53 239.7

(51) Int. Cl. B41F 7/02

(52) U.S. Cl. 101/217

(57) ABSTRACT

Avoiding eccentricity for a shaft, with a balance error, on which a hollow cylinder is applied, the hollow cylinder serving to compensate for the balance error of the shaft. A first mark on the hollow cylinder has a location on the hollow cylinder with a certain thickness of the hollow cylinder, and a second mark on the surface of the shaft has a location on the shaft with a certain radius with respect to the axial center of gravity of the shaft are aligned.

### FIELD OF THE INVENTION

The invention concerns avoiding eccentricities for a shaft by incorporating a hollow cylinder compensating for the balance error of the shaft.

### BACKGROUND OF THE INVENTION

In the manufacture of shafts, certain manufacturing tolerances occur with regard to the roundness of the shaft. Roundness errors caused by manufacturing tolerances are generally negligible and in many cases and do not disrupt the further work procedure. However, manufacturing tolerances can lead to eccentricities since, as the roundness error increases, the axis of the shaft is displaced from the optimum center point of a round shaft, and a balance error arises.

In some applications, the roundness errors are undesired, e.g., in shafts or spindles in the printing industry which support and drive cylinders and transfer a print image to print material. Here, eccentricities can cause the print image to be transferred to an incorrect location, with respect to the transport direction, on the print material. As such, a periodic transfer error is formed.

Especially for use as a printing cylinder, a hollow cylinder is fixed on the shaft which hollow cylinder transfers a print image to the print material. In an essential concept in offset printing (also used in digital printing), the hollow cylinder includes a rubber blanket so that the printing cylinder receives the print image from another printing cylinder and acts as an intermediate carrier of the print image. The hollow cylinder itself exhibits manufacturing tolerances, which are characterized by a different thickness or strength of the hollow cylinder along its circumference. The manufacturing tolerances of the hollow cylinder lead to further roundness errors and eccentricities in the printing cylinder if the hollow cylinder is fastened on the printing cylinder, which results in a further transfer error of the print image on the print material.

### SUMMARY OF THE INVENTION

The object of the invention is to avoid errors in the print image caused by eccentricities. For this purpose, for avoiding eccentricity for a shaft with a balance error on which shaft a hollow cylinder is applied, the hollow cylinder provides compensation for the balance error of the shaft. A shaft provided with a hollow cylinder for avoiding eccentricity, has a first mark at the thinnest location of the hollow cylinder and a congruent second mark at the location on the surface of the shaft at which the shaft exhibits the greatest radius with respect to the axial center of gravity of the shaft.

In an advantageous embodiment, the radius of the axial center of gravity of the shaft is determined, the thickness along the hollow cylinder is determined and the hollow cylinder is applied on the shaft in a manner such that the thinnest location of the hollow cylinder is applied at the location of the shaft at which the shaft exhibits the greatest radius with respect to the axial center of gravity of the shaft.

In a further advantageous embodiment, the thinnest location of the hollow cylinder is designated with a first mark and the location on the surface of the shaft at which the shaft exhibits the greatest radius with respect to the axial center of gravity is designated with a second mark. In this manner, the mounting of the hollow cylinder on the shaft is enabled in a simple manner.

### BRIEF DESCRIPTION OF THE DRAWINGS

The invention is described hereafter in detail based on the following figures:

FIG. 1 is a schematic view of a shaft with a center axis and a uniformly formed hollow cylinder;

FIG. 2 is a schematic view of a shaft with a displaced axis and non-uniformly formed hollow cylinder;

FIG. 3 is a schematic view of a shaft with a displaced axis and a non-uniformly formed hollow cylinder, the hollow cylinder being equalized in a certain manner on the shaft;

FIG. 4 are three curves of eccentricities as a function of the position of a hollow cylinder on a shaft; and

FIG. 5 are three further curves of eccentricities as a function of the position of a hollow cylinder on a shaft.

### DETAILED DESCRIPTION OF THE INVENTION

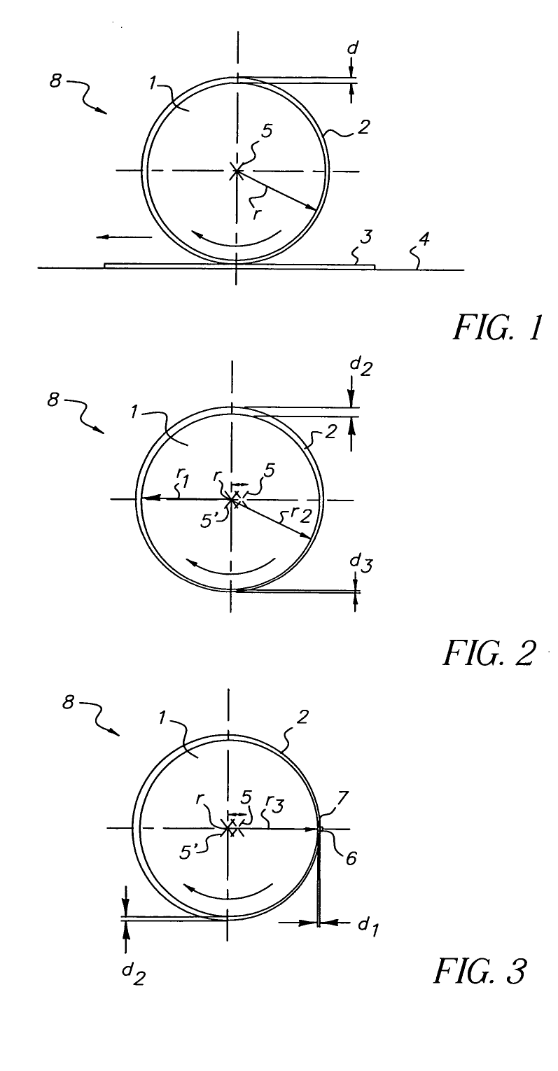

FIG. 1 shows a schematic view of a shaft 1 which is implemented here as a spindle. Around the shaft 1, a hollow cylinder 2 is fastened which is formed, in this example, as a hollow rubber blanket cylinder. In the present example, a spindle is shown with a hollow rubber blanket cylinder for the transfer of a print image from an imaging cylinder to a sheet of print material 3 in digital printing. The print material 3 is conveyed by a continuous conveyor belt 4 in the direction indicated by the arrow.

The shaft 1 is driven through frictional engagement with the conveyor belt 4 and turns in the direction indicated with the curved arrow. The axial center of gravity 5 of the shaft 1 is indicated with a cross; in FIG. 1 every location on the surface of the shaft 1 is located in the optimal position with a constant radius r_{Shaft} from the geometric center of the shaft 1, and is identical to the geometric center of the shaft 1. The shaft 1 exhibits zero manufacturing tolerances, no balance error, and no eccentricities. The hollow cylinder 2 on the shaft 1 has a constant thickness d_{Hollow Cylinder}, or strength, along its circumference. The shaft 1 with hollow cylinder 2 without manufacturing tolerances and balance error enables the printing of a print image on the print material 3 without any errors in print image registration caused by eccentricities.

FIG. 2 shows a shaft 1 with manufacturing tolerances, which lead to a balance error in the shaft 1. The radius r_{Shaft} of the shaft 1 is, considered from the geometric center of the shaft 1, variable. The axial center of gravity 5′ which designates the point about which the shaft 1 turns is not identical to the geometric center of the ideal shaft 1, without any balance error, from FIG. 1. The axial center of gravity 5′ is at a different location than the axial center of gravity 5 from FIG. 1, which is shown for illustration purposes with a broken line in FIGS. 2 and 3. This state is shown by example in FIG. 2 in an exemplary manner with two drawn-in radii r₁ and r₂, which represent radii at different locations of the shaft 1, with r₁ being unequal to r₂.

The radius r₁ designates the minimum radius of the shaft 1 referred to the axial center of gravity 5′, i.e., the distance from the axial center of gravity 5′ to the surface of the shaft 1. The distance arrow of the radius r₁ is shown by example in FIG. 2 in an exemplary manner. The shaft 1 rotates during operation around the axial center of gravity 5′, with eccentricities occurring. The eccentricities are periodic errors, which lead to periodic errors in the print image.

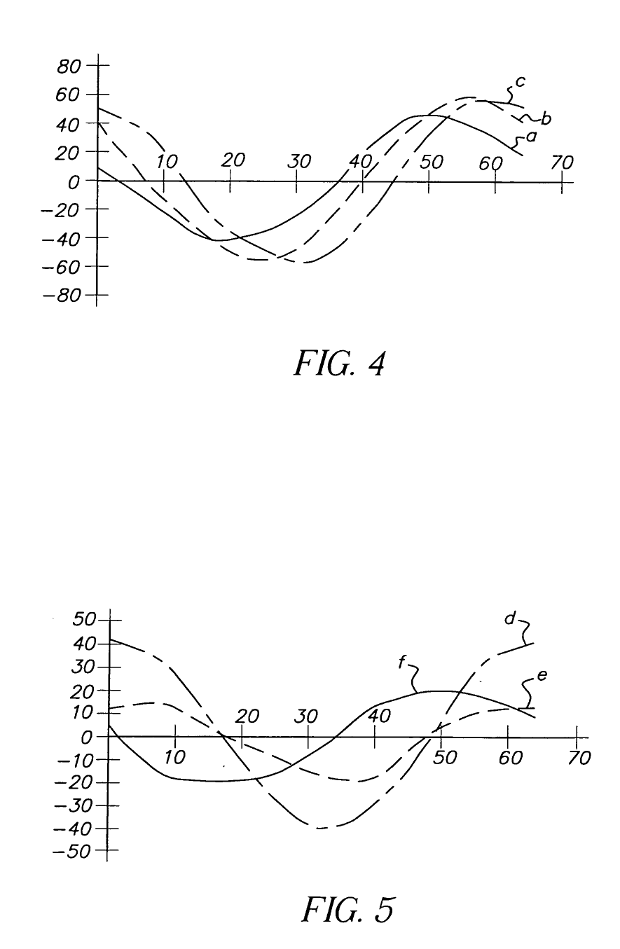

The hollow cylinder 2 fixed on the shaft 1 exhibits manufacturing tolerances; the thickness d_{Hollow Cylinder} of the hollow cylinder 2 is variable along the circumference of the hollow cylinder 2. Different thicknesses d₂ and d₃ at different arbitrary locations on the hollow cylinder 2 are shown by example. Here, the thickness d₂ at an arbitrary location on the hollow cylinder 2 is unequal to the thickness d₃ at another arbitrary location on the hollow cylinder 2. In the prior art, the hollow cylinder 2 is typically located as shown in FIG. 2 on the shaft 1. The hollow cylinder 2 can be applied in any manner on the shaft 1. As a result, there occurs an eccentricity of the shaft 1 similar to the curves a, b, c, and d from FIGS. 4 and 5. In the example, the hollow cylinder 2 is a hollow rubber blanket cylinder, which conforms to the shaft 1 and assumes the shapes of the shaft 1 to a certain degree. Moreover, the manufacturing tolerances of the hollow cylinder 2 lead to further eccentricities of the shaft 1 with hollow cylinder 2 which are superimposed on the eccentricities of the shaft 1.

FIG. 3 shows a shaft 1 with a hollow cylinder 2 fixed on it in an application of an embodiment of the invention. The shaft 1 and the hollow cylinder 2 exhibit manufacturing tolerances, which lead to eccentricities as described for FIG. 2. The shaft 1 exhibits the typical eccentricity along the circumferential angle Φ which has approximately a sinusoidal curve. The local radius r_{Shaft}, i.e., the variable radius r_{Shaft} at a certain location on the shaft 1, is represented mathematically by the following equation:

R_{Shaft}(Φ)=r₀+r_{Eccentric}*sin(Φ) (Equation 1)

In equation 1, r_{Shaft}(Φ) is the radius of the shaft 1 at a circumferential angle Φ, r₀ is the average radius of the shaft 1 at the axial position which is present in the present description, and the distance between the ideal and the distorted (i.e., lying outside of the ideal center of gravity) center of gravity of the shaft is equal to r_{Eccentric}. A variation of the diameter of the shaft 1 in the axial direction is not presented in the description; the diameter of the shaft 1 in the axial direction is assumed to be constant. The radius r₁ designates the minimum radius of the shaft 1 referred to the axial center of gravity 5′, i.e., the distance from the axial center of gravity 5′ to the surface of the shaft 1. The following holds in conjunction with equation 1:

r₁=r₀−r_{Eccentric} (Equation 2)

The fluctuation of the thickness d_{Hollow Cylinder} of the hollow cylinder 2 is represented by the following equation:

D_{Hollow Cylinder}(Φ)=d₀+d_{Eccentric}*sin(Φ+Φ₀) (Equation 3)

In the present equation, d_{Hollow Cylinder}(Φ) designates the thickness of the hollow cylinder 2 at a circumferential angle Φ on the hollow cylinder 2, d₀ designates the average thickness of the hollow cylinder 2 and the angle Φ₀ takes into account the different zero points of the modulations on the shaft 1 and the hollow cylinder 2, i.e., the approximately sinusoidally displaced curve of the eccentricities of the shaft 1, on the one hand, and of the hollow cylinder 2, on the other hand, and the fact that the curves do not coincide. An approximately sinusoidal curve of the thickness fluctuation with the amplitude d_{Eccentric} is caused by the manufacturing technique for the hollow cylinder 2.

The shaft 1 is measured using a suitable measuring device; the result provided by the measurement is the axial center of gravity 5′, as well as the location on the surface of the shaft 1, which exhibits the greatest radius r₃ with respect to the axial center of gravity 5′, it being displaced by 180° with respect to the smallest radius r₁ which designates the distance from the axial center of gravity 5′ to the surface of the shaft 1. The distance arrow of the radius r₃ is shown by example in FIG. 3 in an exemplary manner. Moreover, the thickness d_{Hollow Cylinder} of the hollow cylinder 2 along its circumference is measured which varies along its circumference, and the thinnest location on the hollow cylinder 2 is determined. At the thinnest location of the hollow cylinder 2, the wall strength of the hollow cylinder 2 is the smallest.

Based on the above-described measurements, marks 6 and 7 are applied on the shaft 1 and on the hollow cylinder 2. The hollow cylinder 2 exhibits a first mark 6 on its surface, the shaft 1, has a second mark 7 on its surface. The first mark 6 on the hollow cylinder 2 is at the measured thinnest location of the hollow cylinder 2, the second mark 7 on the shaft 1 is at the location on the surface of the shaft 1 which exhibits the greatest radius r₃ referred to the axial center of gravity 5′ of the shaft 1, i.e., the greatest distance from the axial center of gravity 5′ to the surface of the shaft 1. The two marks 6 and 7 are arranged in a congruent manner over one another when fixing the hollow cylinder 2 on the shaft 1. In this manner, it is guaranteed that the thinnest location of the hollow cylinder 2 is arranged at the greatest radius of the shaft 1. The ensuing benefits are illustrated in FIGS. 4 and 5.

FIG. 4 shows three curves for eccentricities in micrometers as a function of a segment into which the circumference of the shaft 1 is divided. The segment number indicates the position at which the hollow cylinder 2 is fixed on the shaft 1, and encompasses a range of values from 1 to 64, i.e., the shaft 1 is divided into 64 segments. As can be seen in FIG. 4, the fixing of the hollow cylinder 2 at different positions on the shaft 1 leads to different eccentricities. Here, the eccentricities lead to errors in the print image in the transport direction (“intrack errors”) in the micrometer range. As a result of the eccentricities, the print image is printed on the print material displaced in the transport direction. What is shown is a curve a, a curve b and a curve c, the hollow cylinder 2 being displaced from curve a to curve b and from curve b to curve c in each case by 60° with respect to the shaft 1. The position of the hollow cylinder 2 on the shaft 1 which leads to the curve a, is set arbitrarily. In FIG. 4, it can be seen that the position at which the hollow cylinder 2 is fixed on the shaft 1 has great significance for printing in register.

FIG. 5 shows three further curves of eccentricities as a function of the position of a hollow cylinder on a shaft 1, the position of the hollow cylinder 2 in the curve d in comparison to the curve c being displaced by 60° on the shaft 1 and the curves e and f being displaced in each case by a further 60° on the shaft 1. It can be seen that the curves of the eccentricities are flatter compared to FIG. 4; the errors in the print image on the print material 3 grow smaller from curve d to curve e and then become slightly larger in curve f. This means that the hollow cylinder 2 is preferably applied in the position on the shaft 1 which is characterized by the curve e. This is the position of the hollow cylinder 2 on the shaft 1, which results if the following equations are computed. For the angular dependency of the radius of shaft 1 with hollow cylinder 2, the following mathematical relationship exists:

r_{Shaft}+d_{Hollow Cylinder}=r₀+d₀+(r_{Eccentric}−d_{Eccentric})*sin(Φ) (Equation 4)

Here, the radius of the roller 8 is r_{Shaft}=r_{Shaft}+d_{Hollow Cylinder}, i.e., the roller 8 includes the shaft 1 and the hollow cylinder 2.

If r_{Eccentric} is chosen to be equal to d_{Eccentric}, the following theoretical relationship exists:

r_{Cylinder}=r_{Shaft}+d_{Hollow Cylinder}=r₀+d₀ (Equation 5)

Using the relationship represented in equation 5, the best result is obtained in terms of eccentricities. The objective is therefore to match r_{Eccentric} and d_{Eccentric} as closely as possible. The radius r₁=r₀−r_{Eccentric} is the smallest radius on the shaft 1, measured from the axial center of gravity 5′, the thickness d₁=d₀+d_{Eccentric} is the greatest thickness of the hollow cylinder 2. In order to obtain a minimal level of eccentricity, the hollow cylinder 2 is applied on the shaft 1 such that the thinnest location of the hollow cylinder 2 is applied on the location of the shaft 1 at which the shaft 1 exhibits the greatest radius with respect to the axial center of gravity 5′.

The invention has been described in detail with particular reference to certain preferred embodiments thereof, but it will be understood that variations and modifications can be effected within the spirit and scope of the invention.

What is claimed is:

1. A method for avoiding an eccentricity for a shaft (1), with a balance error on which a hollow cylinder (2) is applied, comprising the steps of: determining the radius of the axial center of gravity (5, 5′) of the shaft (1); determining the thickness of the hollow cylinder (2); and, applying the hollow cylinder (2) on the shaft (1) in a manner such that the thinnest location of the hollow cylinder (2) is applied at the location of the shaft (1) at which the shaft (1) exhibits the greatest radius with respect to the axial center of gravity (5, 5′) of the shaft (1).

2. The method according to claim 1, wherein the circumference of the shaft (1) is measured at different locations and, based on the measurements, the axial center of gravity (5, 5′) of the shaft (1) is determined; and the thickness of the hollow cylinder (2) is measured at different locations and, based on the measurements, the thinnest location of the hollow cylinder (2) is determined.

3. The method according to claim 2, wherein thinnest location of the hollow cylinder (2) is designated with a first mark (6), and the location on the surface of the shaft (1) at which the shaft (1) exhibits the greatest radius with respect to the axial center of gravity (5, 5′) is designated with a second mark (7).

4. A shaft (1) having a hollow cylinder (2) surrounding said shaft so as to avoid an eccentricity, comprising: a first mark (6) on the hollow cylinder (2) which has a location on the hollow cylinder (2) with a certain thickness of the hollow cylinder (2), and a second mark (7) on the surface of the shaft (1) which has a location on the shaft (1) with a certain radius with respect to the axial center of gravity (5, 5′) of the shaft (1), wherein said first mark (6) on the thinnest location of the hollow cylinder (2) is congruent second mark (7) on the location on the surface of the shaft (1) at which the shaft (1) has the greatest radius with respect to the axial center of gravity (5, 5′) of the shaft (1).
